(19) United States
(12) Patent Application Publication
(10) Pub. No.: US 2019/0318464 A1
(43) Pub. Date: Oct. 17, 2019

(54) FINGERPRINT IDENTIFICATION MODULE TEST SYSTEM

(71) Applicant: Primax Electronics Ltd., Taipei City (TW)

(72) Inventors: SHENG-CHI CHAN, Taipei City (TW); JUI-TING CHIEN, Taipei City (TW); PEI-MING HSU, Taipei City (TW)

(21) Appl. No.: 15/990,115

(22) Filed: May 25, 2018

(30) Foreign Application Priority Data
Apr. 13, 2018 (TW) 107112777

(51) Int. Cl. G06T 7/00; H04N 5/225; G06K 9/00

(52) U.S. Cl. CPC G06T 7/001; G06K 9/00013; H04N 5/2256

(57) ABSTRACT

A fingerprint identification module test system includes a light source, a projection surface, a low-end image pickup device and a judgment module. The light source emits and projects a light beam onto an under-test fingerprint identification module. After the light beam is reflected by the under-test fingerprint identification module and projected onto the projection surface, a projected image is formed on the projection surface. Then, the low-end image pickup device photographs the projected image to acquire an under-test corresponding to the under-test fingerprint identification module. According to the result of comparing the under-test image with the predetermined image, the judgment module judges whether the under-test fingerprint identification module complies with the production specifications. Since the fingerprint identification module test system uses parity devices to test the under-test fingerprint identification module, the fingerprint identification module test system is cost-effective.

### FIELD OF THE INVENTION

The present invention relates to a test system, and more particularly to a fingerprint identification module test system.

### BACKGROUND OF THE INVENTION

Recently, a fingerprint identification technology has been applied to a variety of electronic products. By using the fingerprint identification technology, the user's fingerprint can be inputted into an electronic product and saved in the electronic product. For unlocking the electronic product, the user has to input the fingerprint through a fingerprint identification module. The way of unlocking the electronic product by the fingerprint identification technology is faster and more user-friendly than the way of manually inputting the password. Consequently, the fingerprint identification technology is favored by many users, and the demands on the fingerprint identification module are gradually increased.

A structure of a conventional fingerprint identification module will be described as follows. FIG. 1 is a schematic exploded view illustrating a structure of a conventional fingerprint identification module. As shown in FIG. 1, the conventional fingerprint identification module 1 comprises a fingerprint sensor 10, a coating structure 11, a circuit board 12, a metallic ring 13 and a supporting plate 14. The fingerprint sensor 10 is disposed on and electrically connected with the circuit board 12 and acquires electric power from the circuit board 12. The fingerprint sensor 10 is used for sensing the user's finger and acquiring the information of the user's finger. The coating structure 11 is disposed on a top surface of the fingerprint sensor 10 by a coating technology. The coating structure 11 is used for protecting the fingerprint sensor 10. Moreover, the coating structure 11 provides a color that matches an electronic device or provides a desired color. The metallic ring 13 is sheathed around the fingerprint sensor 10. The metallic ring 13 is used for transferring the charges of the user's finger or the foreign charges. Consequently, the electrostatic discharge (ESD) is not generated. The supporting plate 14 is used for supporting the above components. Moreover, the supporting plate 14 is contacted with the circuit board 12 to increase the structural strength of the circuit board 12. Consequently, the circuit board 12 is not damaged in response to the external force.

After the fingerprint sensor 10 and the coating structure 11 are combined together or the fingerprint identification module 1 is assembled, it is necessary to test the quality of the combination of the fingerprint sensor 10 and the coating structure 11 or the fingerprint identification module 1 in order to assure no defect or no damage of the fingerprint sensor 10. Generally, the preliminary quality test is manually performed with the naked eyes. The fingerprint sensor 10 or the fingerprint identification module 1 with any macroscopic defect is determined as an unqualified product and the preliminary quality test fails. Whereas, the fingerprint sensor 10 or the fingerprint identification module 1 with no macroscopic defect is determined as a qualified product and the preliminary quality test passes. However, if the fingerprint sensor 10 or the fingerprint identification module 1 has the defect that is unable to be recognized by the naked eyes, the preliminary quality test cannot accurately judge the quality. For solving the above drawbacks, a fingerprint identification module test system for detecting the invisible defect has been introduced into the market.

FIG. 2 schematically illustrates the architecture of a conventional fingerprint identification module test system. As shown in FIG. 2, the conventional fingerprint identification module test system 2 comprises a high-end light source 21, a high-end image pickup device 22 and a judgment module 23. The high-end light source 21 is arranged beside a side of the high-end image pickup device 22. The high-end light source 21 emits coaxial light B1 and projects the coaxial light B1 to an under-test fingerprint identification module 20 in order to provide illumination. The high-end image pickup device 22 is used for acquiring the image of the fingerprint identification module 20. Due to the illumination of the coaxial light B1, the invisible defect can be shown in the image that is acquired by the fingerprint identification module 20. The judgment module 23 is connected with the high-end image pickup device 22. A qualified image 231 corresponding to the qualified fingerprint identification module is stored in the judgment module 23. According to the result of judging whether the acquired image is close to the qualified image 231, the judgment module 23 determines whether the under-test fingerprint identification module 20 passes the quality test or not. Generally, the pixel number of the high-end image pickup device 22 is at least 29 megapixels, and the high-end light source 21 is a coaxial light source.

However, the conventional fingerprint identification module test system still has some drawbacks. For example, the high-end light source 21 and the high-end image pickup device 22 are very expensive. Since the manufacturer is bound to transfer the cost of the above-mentioned component to the price of the fingerprint identification module, the cost of the fingerprint identification module will be increased.

Therefore, there is a need of providing a fingerprint identification module test system with cost-effectiveness.

### SUMMARY OF THE INVENTION

The present invention provides a fingerprint identification module test system with cost-effectiveness.

In accordance with an aspect of the present invention, there is provided a fingerprint identification module test system for judging whether an under-test fingerprint identification module complies with production specifications. The fingerprint identification module test system includes a light source, a projection surface, a low-end image pickup device and a judgment module. The light source emits a light beam and projects the light beam onto the under-test fingerprint identification module. The projection surface receives the light beam from the under-test fingerprint identification module, and generates a projected image corresponding to the under-test fingerprint identification module. The low-end image pickup device acquires the projected image, and generates an under-test image corresponding to the under-test fingerprint identification module. The judgment module is connected with the low-end image pickup device. The judgment module judges whether the under-test fingerprint identification module complies with the production specifications according to a result of comparing the under-test image with a predetermined image. If the under-test image is close to the predetermined image, the judgment module judges that the under-test fingerprint identification module complies with the production specifications. If the under-test image is not close to the predetermined image, the judgment module judges that the under-test fingerprint identification module does not comply with the production specifications.

Preferably, when the light source projects the light beam to the under-test fingerprint identification module, an angle between a projection angle of the light beam and the under-test fingerprint identification module is in a range between 40 and 50 degrees.

From the above descriptions, the present invention provides the fingerprint identification module test system. The light source projects the light beam onto the under-test fingerprint identification module. After the light beam is reflected by the under-test fingerprint identification module and projected onto the projection surface, the projected image is formed on the projection surface. Then, the low-end image pickup device photographs the projected image to acquire the under-test image corresponding to the under-test fingerprint identification module. According to the result of comparing the under-test image with the predetermined image, the judgment module judges whether the under-test fingerprint identification module complies with the production specifications. In comparison with the conventional technology, the fingerprint identification module test system of the present invention uses parity devices to test the under-test fingerprint identification module. Consequently, the fingerprint identification module test system is cost-effective.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a structure of a conventional fingerprint identification module;

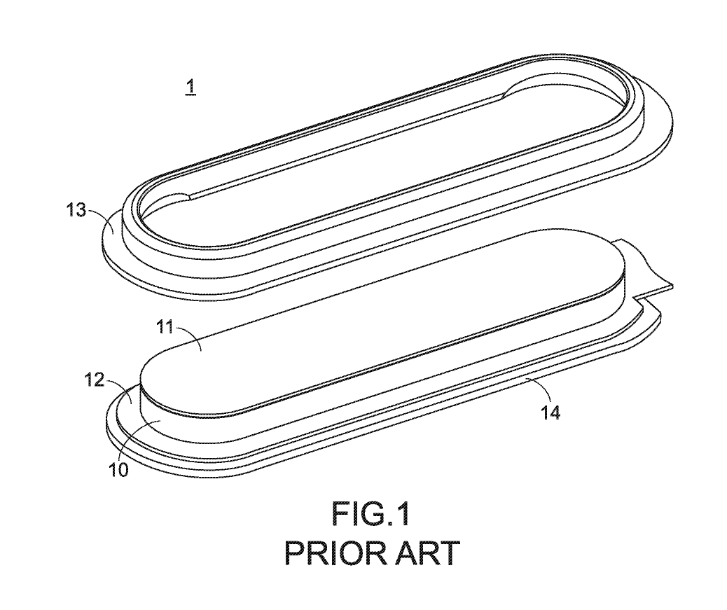

FIG. 2 schematically illustrates the architecture of a conventional fingerprint identification module test system; and

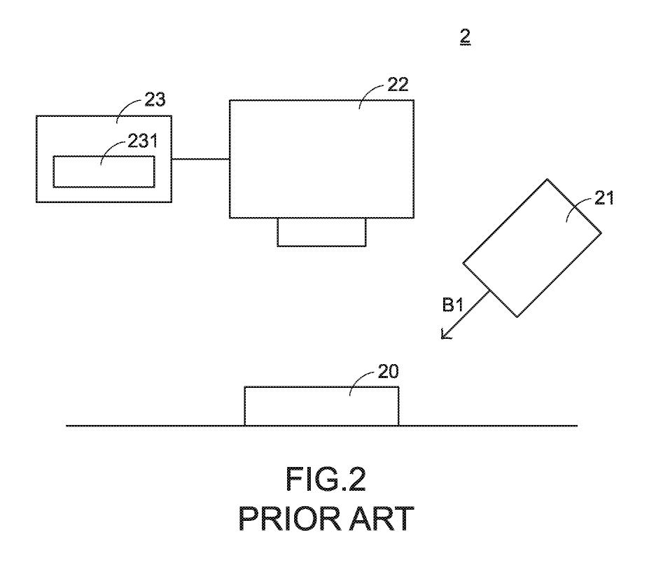

FIG. 3 schematically illustrates the architecture of a fingerprint identification module test system according to an embodiment of the present invention.

### DETAILED DESCRIPTION OF THE PREFERRED EMBODIMENT

For solving the drawbacks of the conventional technologies, the present invention provides a fingerprint identification module test system.

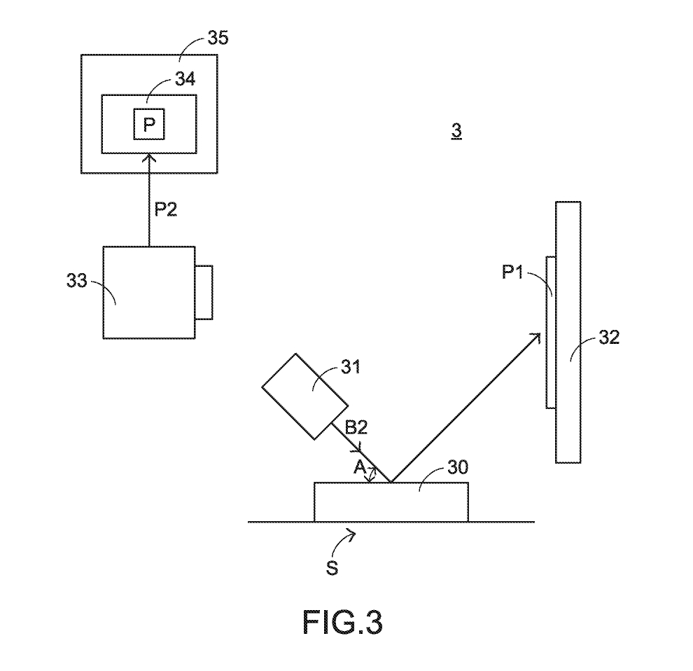

FIG. 3 schematically illustrates the architecture of a fingerprint identification module test system according to an embodiment of the present invention. In FIG. 3, an under-test fingerprint identification module 30 and the fingerprint identification module test system 3 are shown. The fingerprint identification module test system 3 is used for testing whether the under-test fingerprint identification module 30 complies with the production specifications. Like the conventional technology, the under-test fingerprint identification module 30 is the entire of the fingerprint identification module 1 or the combination of the coating structure 11 and the fingerprint sensor 10. The fingerprint identification module test system 3 comprises a light source 31, a projection surface 32, a low-end image pickup device 33 and a judgment module 34. The light source 31 is arranged beside a first side of the under-test fingerprint identification module 30. The light source 31 emits a light beam B2 and projects the light beam B2 onto the under-test fingerprint identification module 30. The projection surface 32 is located beside a second side of the under-test fingerprint identification module 30. The light beam B2 reflected from the under-test fingerprint identification module 30 is received by the projection surface 32. Consequently, a projected image P1 corresponding to the under-test fingerprint identification module 30 is formed on the projection surface 32. In an embodiment, the light source 31 is a low-end light emitting diode or any other appropriate parity light source. For example, the parity light source is a camera lamp of a mobile phone, and the projection surface 32 is a projection screen or a wall surface where the projected image P1 is formed.

In the fingerprint identification module test system 3, the low-end image pickup device 33 is arranged beside the first side of the under-test fingerprint identification module 30. Moreover, the projection surface 32 is located at a focusing location of the under-test fingerprint identification module 30. When the low-end image pickup device 33 photographs the projection surface 32 to acquire the projected image P1, an under-test image P2 corresponding to the under-test fingerprint identification module 30 is generated. In this embodiment, the low-end image pickup device 33 is a camera with a low pixel number. For example, the pixel number of the low-end image pickup device 33 is in the range between 1 megapixel and 5 megapixels.

Please refer to FIG. 3 again. The judgment module 34 is connected with the low-end image pickup device 33. Moreover, a predetermined image P is stored in the judgment module 34. According to the result of comparing the under-test image P2 with the predetermined image P, the judgment module 34 judges whether the under-test fingerprint identification module 30 complies with the production specifications. In an embodiment, the judgment module 34 is a firmware component or a software component that is stored in an electronic device 35. The judgment module 34 is connected with the low-end image pickup device 33 through the electronic device 35. In an embodiment, the predetermined image P is stored in the judgment module 34. It is noted that numerous modifications and alterations may be made while retaining the teachings of the invention. In another embodiment, the predetermined image is stored in the electronic device. During the judging process, the judgment module acquires the predetermined image from the electronic device.

The operations of the fingerprint identification module test system 3 will be described as follows. After the under-test fingerprint identification module 30 is fabricated, the under-test fingerprint identification module 30 is placed at a proper position S of the fingerprint identification module test system 3. When the under-test fingerprint identification module 30 is placed at the proper position S, the light beam B2 is reflected from the under-test fingerprint identification module 30 to the projection surface 32. After the under-test fingerprint identification module 30 is sequentially placed at some positions and the simply adjustment is performed, the proper position S can be obtained. After the under-test fingerprint identification module 30 is placed at a proper position S, the light beam B2 generated by the light source 31 is projected onto the under-test fingerprint identification module 30. In an embodiment, an angle A between a projection angle of the light beam B2 and the under-test fingerprint identification module 30 is in the range between 40 and 50 degrees. The light beam B2 is reflected from the under-test fingerprint identification module 30 to the projection surface 32. Consequently, the projected image P1 corresponding to the under-test fingerprint identification module 30 is formed on the projection surface 32.

Then, the low-end image pickup device 33 photographs the projection surface 32 to acquire the projected image P1. Consequently, the under-test image P2 corresponding to the under-test fingerprint identification module 30 is generated. The under-test image P2 is transmitted to the judgment module 34. After the judgment module 34 receives the under-test image P2, the judgment module 34 compares the under-test image P2 with the predetermined image P according to a similarity recognition algorithm. The principles of the similarity recognition algorithm are well known to those skilled in the art, and are not redundantly described herein. If the under-test image P2 is close to the predetermined image P according to the similarity recognition algorithm, the judgment module 34 judges that the under-test fingerprint identification module 30 complies with the production specifications. Whereas, if the under-test image P2 is not close to the predetermined image P, the judgment module 34 judges that the fingerprint identification module 30 does not comply with the production specifications. That is, the under-test fingerprint identification module 30 is determined as an unqualified product.

The following two aspects should be specially described. Firstly, a process of obtaining the predetermined image P comprises the following steps. Firstly, a qualified fingerprint identification module is placed at the proper position S. Then, the light beam B2 is projected onto the qualified fingerprint identification module. After the light beam B2 is reflected from the qualified fingerprint identification module and projected onto the projection surface 32, the qualified projected image is formed on the projection surface 32. Then, the low-end image pickup device 33 photographs the qualified projected image on the projection surface 32. Consequently, the predetermined image P is acquired. The predetermined image P is transmitted to the judgment module 34. In other words, the way of acquiring the predetermined image P is similar to the way of acquiring the under-test image P2. In contrast, the predetermined image P is acquired from the qualified fingerprint identification module, and the under-test image P2 is acquired from the under-test fingerprint identification module 30. If the under-test fingerprint identification module 30 complies with the production specifications, the under-test image P2 is close to the predetermined image P. Since the under-test image P2 is close to the predetermined image P, the under-test fingerprint identification module 30 complies with the production specifications.

Secondly, if the under-test fingerprint identification module 30 has the invisible defect, the light beam B2 cannot be completely reflected according to the principles of light reflection because of the defect in the under-test fingerprint identification module 30. That is, the light beam B2 is partially refracted. Under this circumstance, the image of the defect in the under-test fingerprint identification module 30 is shown in the projected image P1. The image of the defect is resulted from the light refraction. According to the above principles, if the under-test fingerprint identification module 30 has the defect, the under-test image P2 acquired by the low-end image pickup device 33 contains the image of the defect. Then, the quality test process of the under-test fingerprint identification module 30 can be performed.

From the above descriptions, the present invention provides the fingerprint identification module test system. The light source projects the light beam onto the under-test fingerprint identification module. After the light beam is reflected by the under-test fingerprint identification module and projected onto the projection surface, the projected image is formed on the projection surface. Then, the low-end image pickup device photographs the projected image to acquire the under-test image corresponding to the under-test fingerprint identification module. According to the result of comparing the under-test image with the predetermined image, the judgment module judges whether the under-test fingerprint identification module complies with the production specifications. In comparison with the conventional technology, the fingerprint identification module test system of the present invention uses parity devices to test the under-test fingerprint identification module. Consequently, the fingerprint identification module test system is cost-effective.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A fingerprint identification module test system for judging whether an under-test fingerprint identification module complies with production specifications, the fingerprint identification module test system comprising:
a light source emitting a light beam and projecting the light beam onto the under-test fingerprint identification module;
a projection surface receiving the light beam from the under-test fingerprint identification module, and generating a projected image corresponding to the under-test fingerprint identification module;
a low-end image pickup device acquiring the projected image, and generating an under-test image corresponding to the under-test fingerprint identification module; and
a judgment module connected with the low-end image pickup device, and judging whether the under-test fingerprint identification module complies with the production specifications according to a result of comparing the under-test image with a predetermined image, wherein if the under-test image is close to the predetermined image, the judgment module judges that the under-test fingerprint identification module complies with the production specifications, wherein if the under-test image is not close to the predetermined image, the judgment module judges that the under-test fingerprint identification module does not comply with the production specifications.

2. The fingerprint identification module test system according to claim 1, wherein when the light source projects the light beam onto the under-test fingerprint identification module, an angle between a projection angle of the light beam and the under-test fingerprint identification module is in a range between 40 and 50 degrees.

3. The fingerprint identification module test system according to claim 1, wherein the judgment module is installed within an electronic device, and the predetermined image is stored in the judgment module or the electronic device.

4. The fingerprint identification module test system according to claim 1, wherein when the low-end image pickup device photographs a qualified projected image on the projection surface, the predetermined image is acquired, wherein when the light beam reflected from a qualified fingerprint identification module is projected onto the projection surface, the qualified projected image is formed on the projection surface.

5. The fingerprint identification module test system according to claim 1, wherein the judgment module compares the under-test image with the predetermined image according to a similarity recognition algorithm.

6. The fingerprint identification module test system according to claim 1, wherein the light source is a light emitting diode.

7. The fingerprint identification module test system according to claim 1, wherein the low-end image pickup device is a camera with a low pixel number, and a pixel number of the low-end image pickup device is in a range between 1 megapixel and 5 megapixels.

8. The fingerprint identification module test system according to claim 1, wherein the projection surface is a projection screen or a wall surface.
